(19) United States
(12) Patent Application Publication
(10) Pub. No.: US 2011/0035410 A1
(43) Pub. Date: Feb. 10, 2011

(54) PROCESSING APPARATUS AND PROGRAM

(76) Inventors: Hideki Takano, Kawasaki (JP); Kojiro Nakayama, Yokohama (JP)

Correspondence Address: BRUNDIDGE & STANGER, P.C., 2318 MILL ROAD, SUITE 1020, ALEXANDRIA, VA, 22314, US

(21) Appl. No.: 12/899,865

(22) Filed: Oct. 7, 2010

Related U.S. Application Data
(63) Continuation of application No. 11/774,788, filed on Jul. 9, 2007, now abandoned.

(30) Foreign Application Priority Data
Jul. 12, 2006 (JP) 2006-191097
Jun. 18, 2007 (JP) 2007-159657

(51) Int. Cl. G06F 17/30

(52) U.S. Cl. 707/790; 707/E17.005

(57) ABSTRACT

To reduce the processing load for processing structured data pieces in different representation forms, a path correspondence table storage area stores a path correspondence table having a correspondence between first position information for locating an item of a first structured data piece and second position information for locating the item of a second structured data piece, having a different representation form from that of the first structured data piece and corresponding to the item located by the first position information. If the first position information is specified, and a request for obtaining information relating to an item in the second structured data piece is received, a path converting section uses the path correspondence table to convert the first position information to the second position information and obtain the information relating to the item from the second structured data piece stored in a structured data storage area.

This application is a continuation application of U.S. application Ser. No. 11/774,788, filed on Jul. 9, 2007, the entirety of which is incorporated herein by reference.

### FIELD OF THE INVENTION

The present invention relates to a technology that processes structured documents created in different representation forms.

### BACKGROUND OF THE INVENTION

Conventionally, in order to process structured data in different representation forms, structured data in various representation forms are converted to structured data in a common representation form, and necessary data is then referred or updated (refer to Patent Document 1: JP-A-2002-259654, for example)

### SUMMARY OF THE INVENTION

Processing structured data in different representation forms after converting them to structured data in a common representation form as in the conventional technology requires the conversion of the entire structured data even when a part of the structured data is only necessary, for example, which increases the processing load.

Furthermore, in order to convert structured data in different representation forms, a conversion definition must be created for each representation form to be converted in the conventional technology, which is inconvenient.

Accordingly, the first object of the invention is to reduce the processing load for processing structured data pieces in different representation forms.

The second object of the invention is to reduce the load for creating a conversion definition for each representation form.

In order to achieve the objects, a first invention of this application allows retrieving and processing information relating to a required item from a structured data piece in different representation forms by converting information for locating the item in the structured data piece.

For example, there is provided a processing apparatus including a storage section that stores a first structured data piece having at least one item, an obtaining section that obtains information relating to the item from the first structured data piece, and a converting section that converts second position information for locating an item of a second structured data piece in a different representation form from that of the first structured data piece to first position information for locating the item of the first structured data piece, wherein the obtaining section obtains information relating to the item from the first structured data piece by using the first position information converted by the converting section.

A second invention of this application can create a conversion definition for different structured data pieces by converting information for locating an item to information for locating the item in different structured data pieces in a conversion definition for performing a predetermined conversion process by locating positions of an item in structured data pieces.

For example, there is provided a processing apparatus including a creating section that creates a second data conversion definition from a first data conversion definition, the first data conversion definition converting a second structured data piece having at least one item to a third structured data piece, which is different from the second structured data piece, having at least one item, the second data conversion definition converting a first structured data piece, which is different from the second and third structured data pieces, having at least one item to the third structured data piece, wherein the first data conversion definition includes third position information locating the item having information to be obtained from the second structured data piece and fourth position information locating the item under which the information obtained from the item located by the third position information is to be captured to the third structured data piece, and the creating section creates the second data conversion definition by replacing the third position information of the first data conversion definition by first position information for locating the item of the first structured data piece, which corresponds to the item located by the third position information.

As described above, according to the first invention, the conversion of information for identifying an element in structured data pieces allows processing by identifying a necessary element from the structured data pieces and eliminates the necessity for converting the entire structured data, which allows fast processing.

According to the second invention, a conversion definition for different structured data pieces can be created by converting information for identifying an element in conversion definitions. Thus, the load of creating conversion definitions for different structured data pieces can be reduced, and the conversion of structured data pieces can be performed efficiently.

### BRIEF DESCRIPTION OF THE DRAWINGS

FIG. 1 is a schematic diagram of a processing apparatus 100.

FIG. 2 is a schematic diagram of a structured data piece 160 of a first type.

FIG. 3 is a schematic diagram of a structured data piece 161 of a second type.

FIG. 4 is a schematic diagram of a path correspondence table 162.

FIG. 5 is a flowchart showing processing of obtaining a predetermined data piece from a structured data piece.

FIG. 6 is a schematic diagram of a processing apparatus 200.

FIG. 7 is a schematic diagram of a path correspondence table 262.

FIG. 8 is a schematic diagram of a conversion table 263.

FIG. 9 is a flowchart showing processing of creating a data conversion definition.

FIG. 10 is a schematic diagram of a data conversion definition 264.

FIG. 11 is a schematic diagram of a path correspondence table 262.

FIG. 12 is a schematic diagram of a data conversion definition 265.

FIG. 13 is a schematic diagram of a path input dialog screen 166.

FIG. 14 is a schematic diagram of a data conversion definition 167.

FIG. 15 includes schematic diagrams of a structured data piece 168 and a structured data piece 169.

FIG. 16 is a schematic diagram of a path correspondence table 362.

FIG. 17 is a schematic diagram of a path correspondence table 462.

FIG. 18 is a diagram showing effectiveness of a second embodiment.

FIG. 19 is a flowchart showing processing of performing path conversion during a data conversion operation.

FIG. 20 is a schematic diagram of a system that mediates service invoking.

FIG. 21 is a schematic diagram of a service invoking control definition table 780.

FIG. 22 includes schematic diagrams of request data.

FIG. 23 is a schematic diagram of a path correspondence table 810.

FIG. 24 is a flowchart showing processing on a service invoking control definition.

FIG. 25 is a schematic diagram of a service invoking control definition table 830.

FIG. 26 is a flowchart showing processing of creating a service invoking control definition.

### DESCRIPTION OF THE PREFERRED EMBODIMENTS

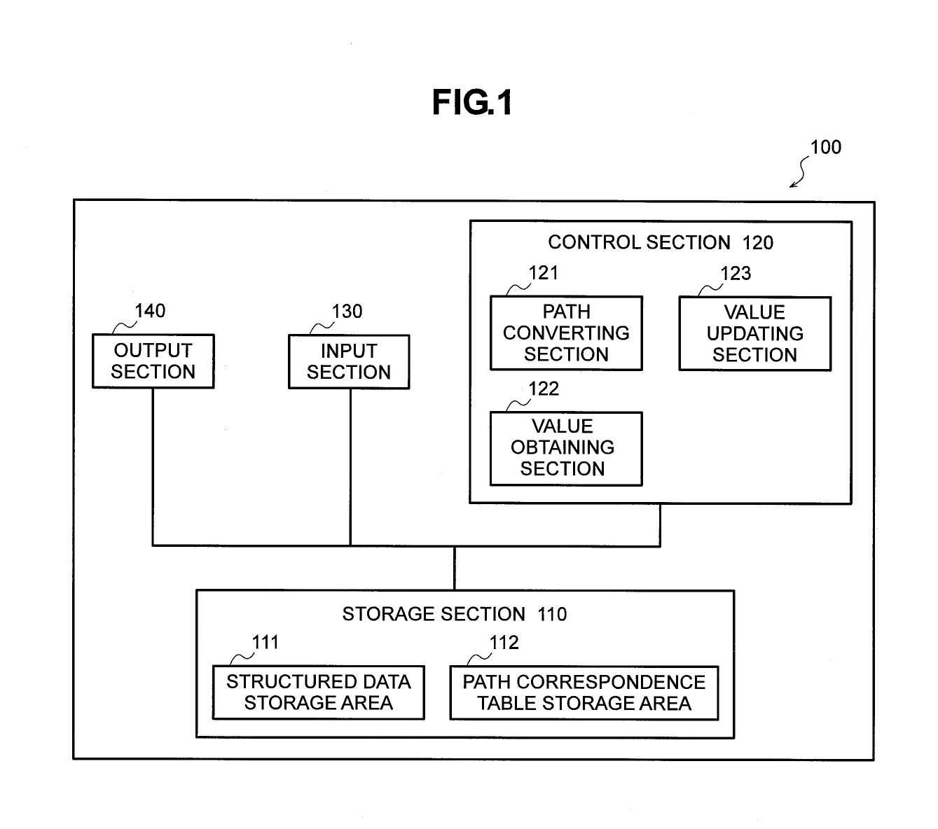

FIG. 1 is a schematic diagram of a processing apparatus 100, which is a first embodiment of the invention.

As shown in FIG. 1, the processing apparatus 100 includes a storage section 110, a control section 120, an input section 130 and an output section 140.

The storage section 110 has a structured data storage area 111 and a path correspondence table storage area 112.

The structured data storage area 111 stores a structured data piece having at least one item.

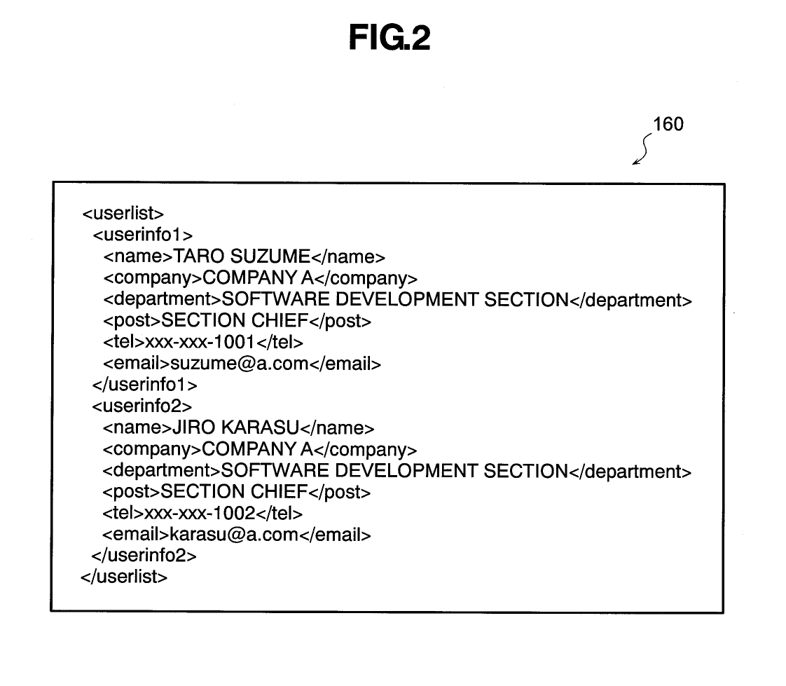

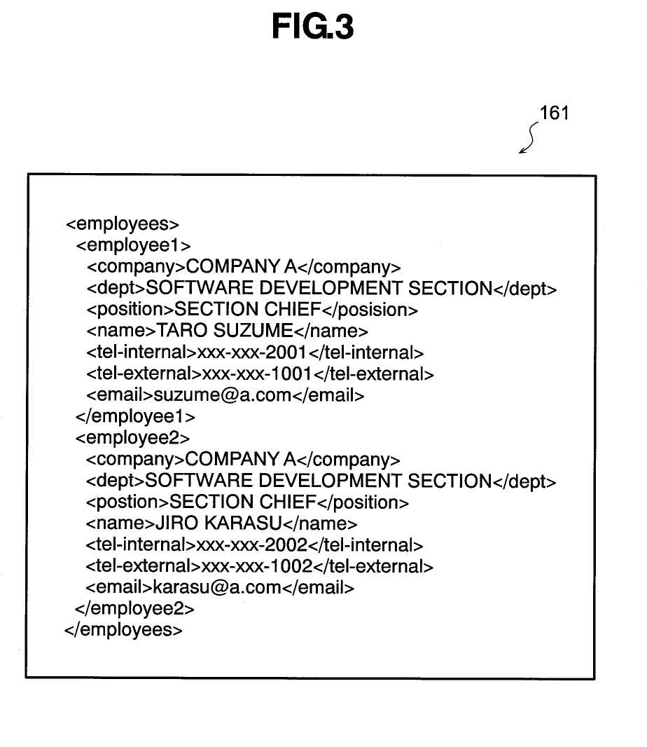

According to this embodiment, a structured data piece 160 of a first type as shown in FIG. 2 and a structured data piece 161 of a second type as shown in FIG. 3 are stored. Notably, these structured data pieces are not necessarily stored in the storage section 110 and may be externally input when processing is performed.

Here, the structured data piece 160 of the first type and the structured data piece 161 of the second type specify at least one item and have different representation forms.

For example, both of the structured data 160 of the first type and the structured data piece 161 of the second type specify data pieces for managing employees belonging to an company, and, in this case, specify items including a name, a company name, a section name, a post, a telephone number and an electronic mail address for each employee by XML (eXtensible Markup Language), but the representation forms are different.

In other words, in the structured data piece 160 of the first type, “userlist” is a root element, and a tag including “userinfo” with an ID number is defined for each employee as a child element. A name is identified by a tag “name”, and a company name is identified by a tag “company”. A section is identified by a tag “department”, and a post is identified by a tag “post”. A telephone number is identified by a tag “tel”, and an electronic mail address is identified by a tag “email”.

On the other hand, in the structured data piece 161 of the second type, “employees” is a root element, and a tag including “employee” with an ID number is defined for each employee as a child element. A company name is identified by a tag “company”. A section is identified by a tag “dept”, and the post is identified by a tag “position”. A name is identified by a tag “name”. An extension telephone number is identified by a tag “tel-internal”, and an outside telephone number is identified by a tag “tel-external” (which corresponds to the telephone number in the structured data piece 160 of the first type) and an electronic mail address is identified by a tag “email”.

The path correspondence table storage area 112 stores table information having a correspondence between position information for locating an item of one structured data piece stored in the structured data storage area 111 and position information for locating the item corresponding to the one structured data piece in another structured data piece.

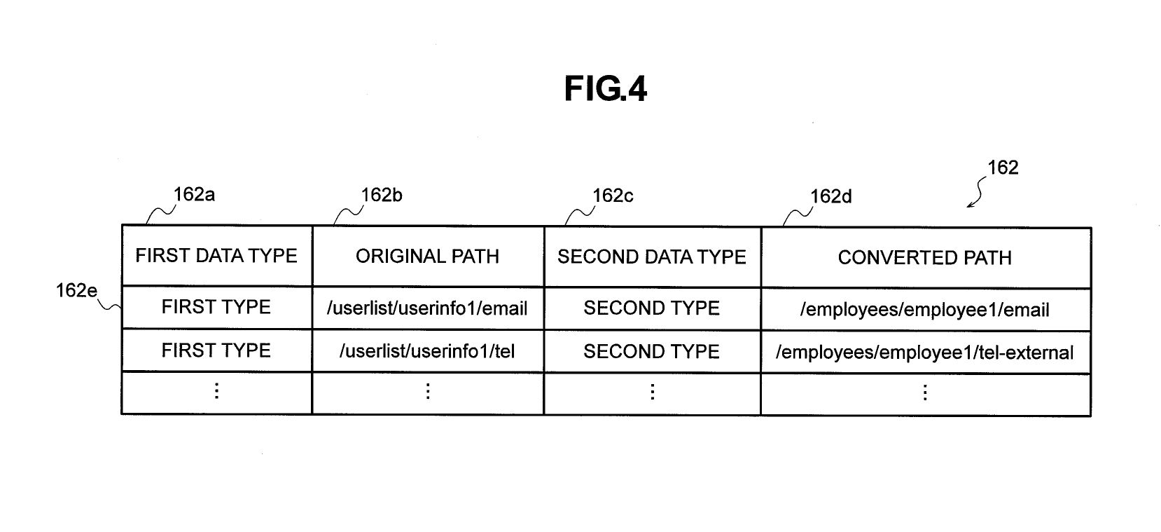

For example, according to this embodiment, a path correspondence table 162 as shown in FIG. 4 is stored.

The path correspondence table 162 includes a first data type field 162a, an original path field 162b, a second data type field 162c, and a converted path field 162d.

The first data type field 162a stores information for identifying a data type, which is a representation form, of a structured data piece for locating an item by an XPath to be stored in the original path field 162b, which will be described later.

The original path field 162b stores position information for locating a specific item in a structured data piece created by a representation form identified by the first data type field 162a.

Here, according to this embodiment, since the structured data piece is described in XML, an XPath (XML Path Language) is stored as position information.

The second data type field 162c stores information for identifying a data type, which is a representation form, of a structured data piece for locating the item based on an XPath stored in the converted path field 162d, which will be described later.

The converted path field 162d stores an XPath for specifying the node corresponding to the node specified by the XPath stored in the original path field 162b in the structured data piece created in the representation form identified by the second data type field 162c.

For example, for the structured data piece 160 of the first type on a first row 162e on the path correspondence table 162, “/userlist/userinfo1/email”, which is an XPath for specifying the “email” of an employee identified by the “userinfo1” is stored in the original path 162b. For the structured data piece 161 of the second type thereon, “/employees/employee/email”, which is an XPath for specifying the “email” of the employee, is stored in the converted path 162d.

The control section 120 has a path converting section 121, a value obtaining section 122 and a value updating section 123.

The path converting section 121 receives the inputs of an XPath, an original data type and a converted data type through the input section 130, which will be described later. If the input original data type is different from the converted data type, the row on the path correspondence table 162 is stored which stores the input original data type in the first data type field 162a, the input XPath in the original path field 162b and the input converted data type in the second data type field 162c. The XPath stored in the converted path field 162d on the identified row is extracted, and the extracted XPath and input converted data type are transmitted to the value obtaining section 122, which will be described later.

On the other hand, if the input original data type is identical to the converted data type, the path converting section 121 transmits the input XPath and the input converted data type to the value obtaining section 122, which will be described later.

The value obtaining section 122 identifies the structured data piece, which corresponds to the data type transmitted from the path converting section 121, in the structured data storage area 111, obtains the data stored in the node corresponding to the XPath, which is transmitted to the path converting section 121, from the identified structured data piece and outputs the data to the output section 140, which will be described later.

When an instruction to update, that is, to perform touchup work on, for example, the data obtained by the value obtaining section 122 is given through the input section 130, which will be described later, the value updating section 123 performs processing of obtaining the data type and XPath, which correspond to the obtained data, from the value obtaining section 122, identifying the structured data piece, which corresponds to the obtained data type, from the structured data storage area 111, and storing the updated data at the node position corresponding to the obtained XPath.

The input section 130 may receive the inputs of a structured data piece to be stored in the structured data storage area 111 and a path correspondence table to be stored in the path correspondence table storage area 112 and also receive the inputs of an original data type, converted data type and XPath for obtaining data from the structured data piece stored in the structured data storage area 111.

The input section 130 receives the inputs of information to be updated and an instruction to update and transmits them to the value updating section 123.

The output section 140 outputs, that is, displays or prints, for example, the data obtained by the value obtaining section 122 in a predetermined form.

The processing apparatus 100 described above can be implemented by a computer. For example, the storage section 110 is configurable by an external storage device such as a memory and a hard disk. The control section 120 can be implemented by executing a predetermined program stored in an external storage device, for example, in a CPU (Central Processing Unit). The input section 130 can be implemented by an input device such as a mouse and a keyboard or an input interface through which information can be input. The output section 140 can be implemented by a display device or an output interface through which information can be output.

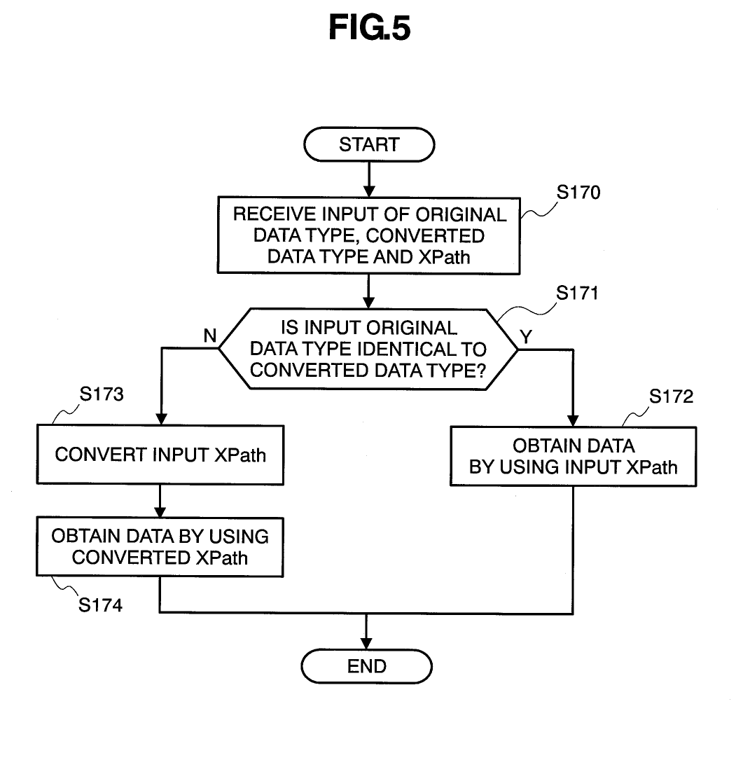

Processing of obtaining a predetermined data piece from a structured data piece in the processing apparatus 100 having the construction above will be described with reference to the flowchart shown in FIG. 5.

First of all, the processing apparatus 100 receives the inputs of an original data type, a converted data type and an XPath through the input section 130 (S170) and starts the processing.

The input original data type and converted data type are transmitted to the path converting section 121 through the input section 130, and whether these data types are identical or not is determined by the path converting section 121 (S171).

Then, if these data types are identical (S171), the path converting section 121 transmits the input original data type and input XPath to the value obtaining section 122. The value obtaining section 122 identifies the structured data piece corresponding to the original data type in the structured data storage area 111 and obtains the data piece corresponding to the node corresponding to the XPath in the identified structured data (S172).

On the other hand, if the input original data type is different from the converted data type (S171), the path converting section 122 searches through the path correspondence table 162 stored in the path correspondence table storage area 112, identifies the row on the pass correspondence table 162 storing the input original data type in the first data type field 162a, the input XPath in the original path field 162b and the input converted data type in the second data type field 162c, extracts the XPath stored in the converted path field 162d on the identified row, transmits the extracted XPath and input converted data type to the value obtaining section 122 (S173). The value obtaining section 122 identifies the structured data piece corresponding to the converted data type in the structured data storage area 111 and obtains the data piece corresponding to the node corresponding to the XPath in the identified structured data piece (S174).

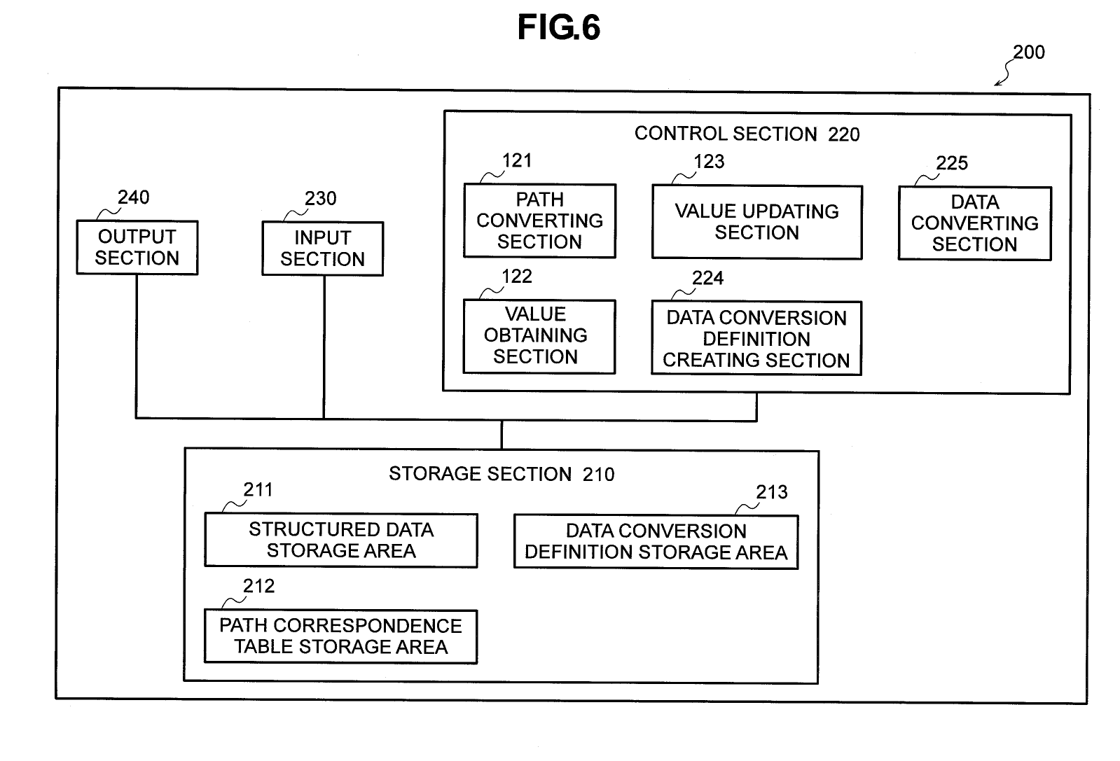

FIG. 6 is a schematic diagram of a processing apparatus 200 according to a second embodiment of the invention.

Having described the first embodiment in that the data types of to structured data pieces in different representation forms include two types of the first and second types, this embodiment will be described based on structured data pieces of types including 26 types from data_a to data_z and a type of data_common.

As shown in FIG. 6, the processing apparatus 200 includes a storage section 210, a control section 220, an input section 230 and an output section 240.

The storage section 210 has a structured data storage area 211, a path correspondence table storage area 212 and a data conversion definition storage area 213.

The structured data storage area 211 stores a structured data piece having at least one item, like the first embodiment. Notably, the structured data piece is not necessarily stored in the storage section 210 and may be externally input when processing is performed.

The path correspondence table storage area 212 stores table information having a correspondence between position information for locating an item of one structured data piece stored in the structured data storage area 211 and position information for locating the item corresponding to the item of the one structured data piece in another structured data piece, like the first embodiment.

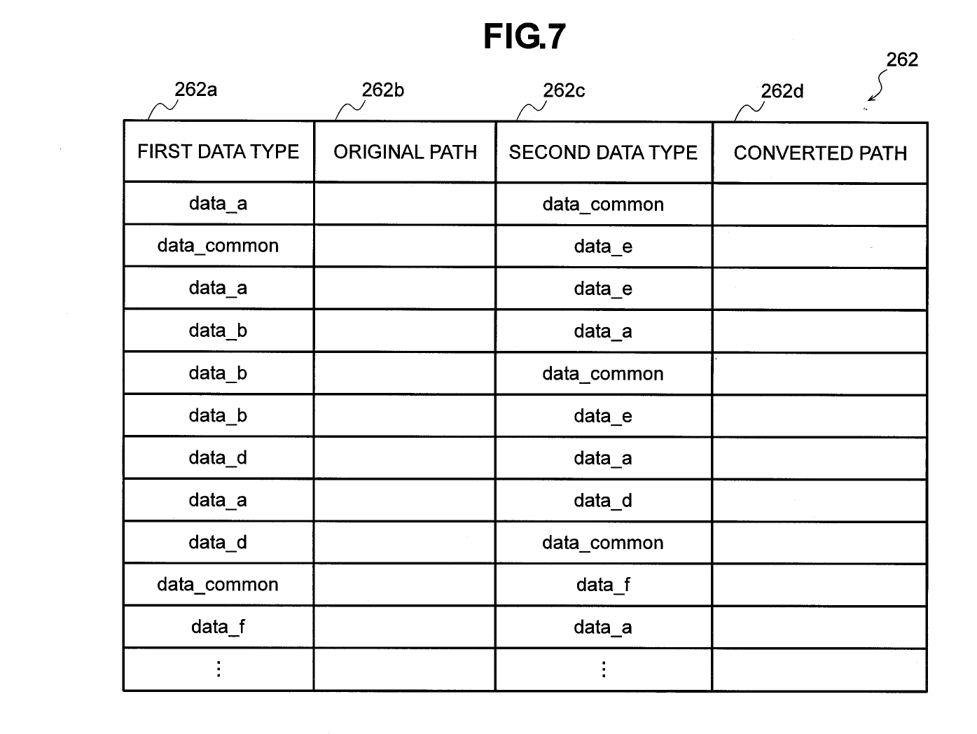

For example, also in this embodiment, the path correspondence table 262 including a first data type field 262a, an original path field 262b, a second data type field 262c, and a converted path field 262d is stored, as shown in FIG. 7.

The data conversion definition storage area 213 stores information for identifying an original data type, information for identifying a converted data type, and a conversion definition for converting from an original data type to a converted data type.

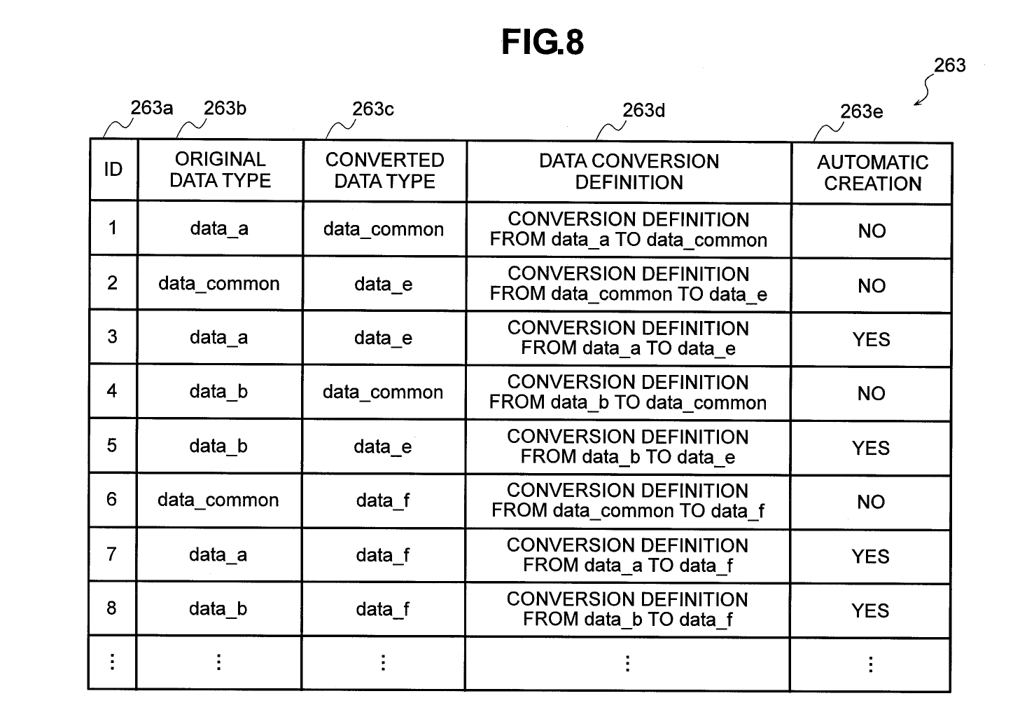

For example, the data conversion definition storage area 213 stores a conversion table 263 as shown in FIG. 8.

The conversion table 263 has an ID field 263a, an original data type field 263b, a converted data type field 263c, a data conversion definition field 263d and an automatic creation field 263e.

The ID field 263a stores identification information for uniquely identifying a data conversion definition stored in the data conversion definition field 263d.

The original data type field 263b stores a data type for identifying the representation form of a structured data piece before conversion (that is, original structured data piece) to be converted based on a data conversion definition stored in the data conversion definition field 263d.

The converted data type field 263c stores a data type for identifying the representation form of a structured data piece after conversion (that is, converted structured data piece) to be converted based on a data conversion definition stored in the data conversion definition field 263d.

The data conversion definition field 263d stores a data conversion definition for converting an original structured data piece identified by the data type stored in the original data type field 263b to the converted structured data piece identified by the data type stored in the converted data type field 263c.

Here, according to this embodiment, the structured data piece to be converted is created in XML, and an XSLT (XSL Transformations) stylesheet is used as the data conversion definition.

The automatic creation field 263e stores information for determining whether the data conversion definition stored in the data conversion definition field 263d has been automatically created in the processing apparatus 200 as described later or not.

Here, in this embodiment, if the data conversion definition stored in the data conversion definition field 263d has been automatically created in the processing apparatus 200, a word “YES” is stored in the field while a word “NO” is stored in the field if not.

The control section 220 has a path converting section 121, a value obtaining section 122, a value updating section 123 and a data conversion definition creating section 224 and a data converting section 225.

Here, since the processing to be performed in the pass converting section 121, value obtaining section 122 and value updating section 123 is the same as that of the first embodiment, the description thereon will be described.

If the data conversion definition creating section 224 receives the inputs of a data conversion definition specifying an original data type and a converted data type through the input section 230, which will be described later, the data conversion definition creating section 224 creates a data conversion definition between the data type the data conversion definition for which has been already stored in the data conversion definition storage area 213 and the newly input data type.

More specifically, if the input original data type has been stored in the original data type field 263c of the conversion table 263, the data conversion definition creating section 224 first extracts the data types stored in the original data type field 263b, which is stored on one row (identifiable by one ID), and creates a synthesis list.

Then, each data type on the created synthesis list is extracted one by one, and the extracted data type is stored in the first data type field 262a. Then, the row having the second data type field 262c storing the input original data type is identified in the path correspondence table 262. If the XPath corresponding to the XPath stored in the converted path field 262d on the identified row is included in the input data conversion definition, the XPath included in the data conversion definition is replaced by the XPath stored in the original path field 262b. Thus, a data conversion definition is created for converting the representation form from the extracted data type to the input data type.

By repeating the processing, the data conversion definition creating section 224 creates a data conversion definition for converting the representation form from the data type the data conversion definition has for which been already created to a new data type.

Next, if the input converted data type is stored in the original data type field 263b of the conversion table 263, the data conversion definition creating section 224 extracts data types, which is stored in the converted data type field 263c on one row (identifiable by one ID) and creates a synthesis list.

Then, each data type on the created synthesis list is extracted one by one, and the extracted data type is stored in the second data type field 262c. The row storing the input converted data type in the first data type field 262a is identified in the path correspondence table 262. If the XPath corresponding to the XPath stored in the original path field 262b on the identified row is included in the input data conversion definition, the XPath included in the data conversion definition is replaced by the XPath stored in the converted path field 262d. Thus, a data conversion definition is created for converting the representation form from the input data type to the extracted data type.

By repeating the processing, the data conversion definition creating section 224 creates a data conversion definition for converting the representation form from a new data type to the data type for which the data conversion definition has been already created.

The data converting section 225 converts the representation form of the structured data piece input through the input section 230 or the structured data piece stored in the structured data storage area 211 by using a data conversion definition stored in the data conversion definition storage area 213. Notably, since the processing has been performed conventionally, the description thereon will be omitted herein.

The input section 230 receives the input of similar information to those of the first embodiment and further receives the input of a data conversion definition for converting the representation form from the data type the data conversion definition for which has been already stored in the data conversion definition storage area 213 to the converted or original data type in order to create a data conversion definition in the data conversion definition creating section 224.

The output section 240 outputs similar information to those of the first embodiment and further outputs, in a predetermined form, a structured data piece converted by the data converting section 225.

The processing apparatus 200 described above can also be implemented by a computer, like the first embodiment. For example, the storage section 210 is configurable by an external storage device such as a memory and a hard disk. The control section 220 can be implemented by executing a predetermined program stored in an external storage device by a CPU (Central Processing Unit). The input section 230 can be implemented by an input device such as a mouse and a keyboard or an input interface through which information can be input. The output section 240 can be implemented by a display device or an output interface through which information can be output.

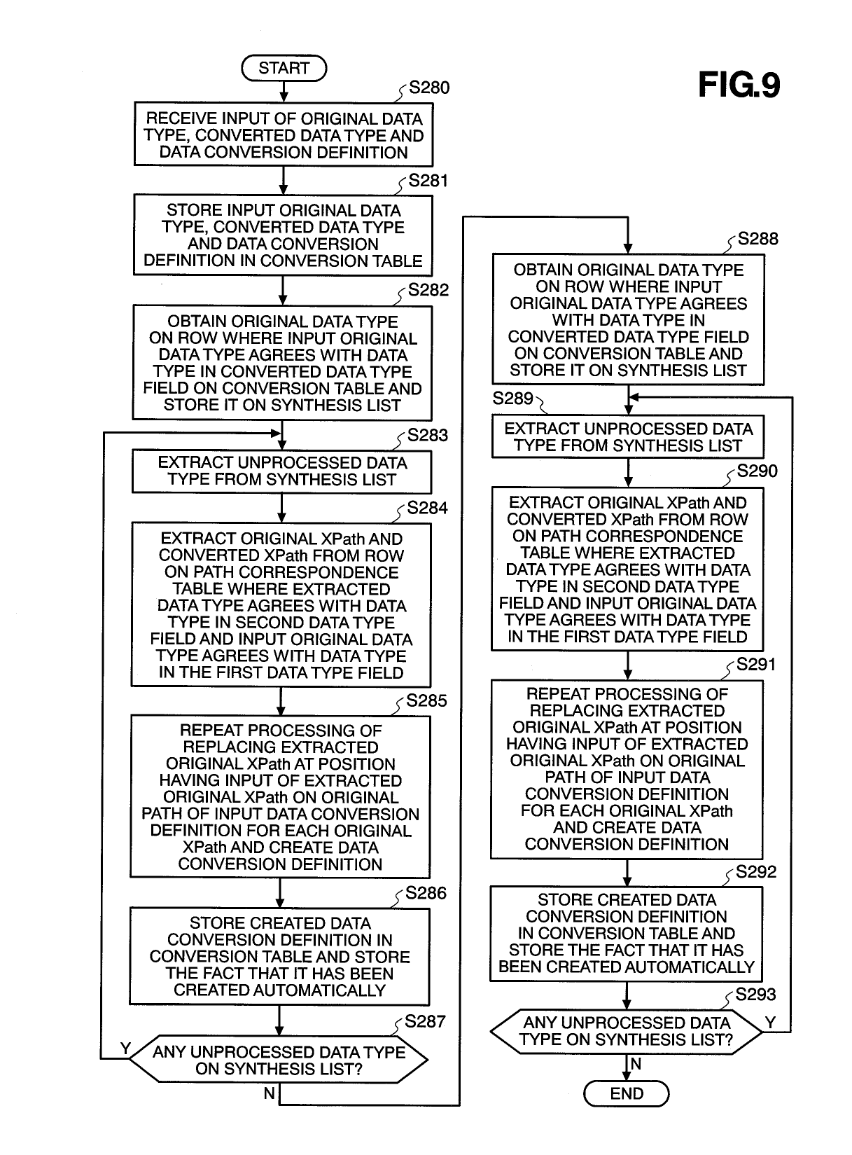

The processing of creating a data conversion definition in the processing apparatus 200 having this construction will be described by using the flowchart shown in FIG. 9.

First of all, the processing is started by receiving an original data type, a converted data type and a data conversion definition through the input section 230 (S280).

Then, the data conversion definition creating section 224 stores the input original data type, converted data type and data conversion definition in applicable fields of the conversion table 263 of the data conversion definition storage area 213 (S281). In this case, in order to prevent the overlap with other data conversion definitions, an ID is given to a data conversion definition, which is then stored in an ID field 263a, and the word, “NO”, is stored in the automatic creation field 263e.

Next, the data conversion definition creating section 224 obtains the original data type on a row where the input original data type agrees with the data type in the converted data type field 263c on the data conversion table 263 and stores it in a synthesis list (S282).

Next, the data conversion definition creating section 224 extracts an unprocessed data type from the synthesis list (S283) and identifies, on the path correspondence table 262, the row where the extracted data type agrees with the data type in the second data type field 262a and the input original data type agrees with the data type in the first data type field 262c and extracts the XPath stored in the original path field 262b and the XPath stored in the converted path field 262d from the identified row (S284).

Then, the data conversion definition creating section 224 creates a data conversion definition by repeating the processing of replacing each extracted original XPath by the converted XPath, which has been extracted from the same row, at a position having the extracted original XPath in the original path of the input data conversion definition (S285).

The data conversion definition created in this way is stored in the data conversion definition field 263d in the conversion table 263 (S286). In this case, in order to prevent the overlap with other data conversion definitions, an ID is given to the data conversion definition, which is then stored in the ID field 263a. The data type extracted from the synthesis list is stored in the original data type field 263b. The input converted data type is stored in the converted data type field 263c. The word, “YES”, is stored in the automatic creation field 263e.

Then, if the synthesis list still has an unprocessed data type (S287), the processing in steps S284 to S286 is repeated thereon.

The data conversion definition creating section 224 obtains the converted data type on a row where the input converted data type agrees with the data type in the original data type field 263b on the data conversion table 263 and stores it in a synthesis list (S288).

Next, the data conversion definition creating section 224 extracts an unprocessed data type from the synthesis list (S289) and identifies the row on the path correspondence table 262 where the extracted data type agrees with the data type in the second data type field 262c and the input original data type agrees with the data type in the first data type field 262a and extracts the XPath stored in the original path field 262b and the XPath stored in the converted path field 262d from the identified row (S290).

Then, the data conversion definition creating section 224 creates a data conversion definition by repeating the processing of replacing each extracted original XPath by the converted XPath, which has been extracted from the same row at a position having the extracted original XPath in the converted path of the input data conversion definition (S291).

The data conversion definition created in this way is stored in the data conversion definition field 263d in the conversion table 263 (S292). In this case, in order to prevent the overlap with other data conversion definitions, an ID is given to the data conversion definition, which is then stored in the ID field 263a. The input original data type is stored in the original data type field 263b. The data type extracted from the synthesis list is stored in the converted data type field 263c. The word, “YES”, is stored in the automatic creation field 263e.

Then, if the synthesis list still has an unprocessed data type (S293), the processing in steps S289 to S292 is repeated thereon.

Having illustrated in the flowchart shown in FIG. 9 the processing of creating a new conversion definition by steps of changing the original data type of a data conversion definition input through the input section 230 to a different data type, then changing the converted data type of the input data conversion definition to a different data type, the invention is not limited to this embodiment. The steps may be performed in the reversed order, or only one of them may be created.

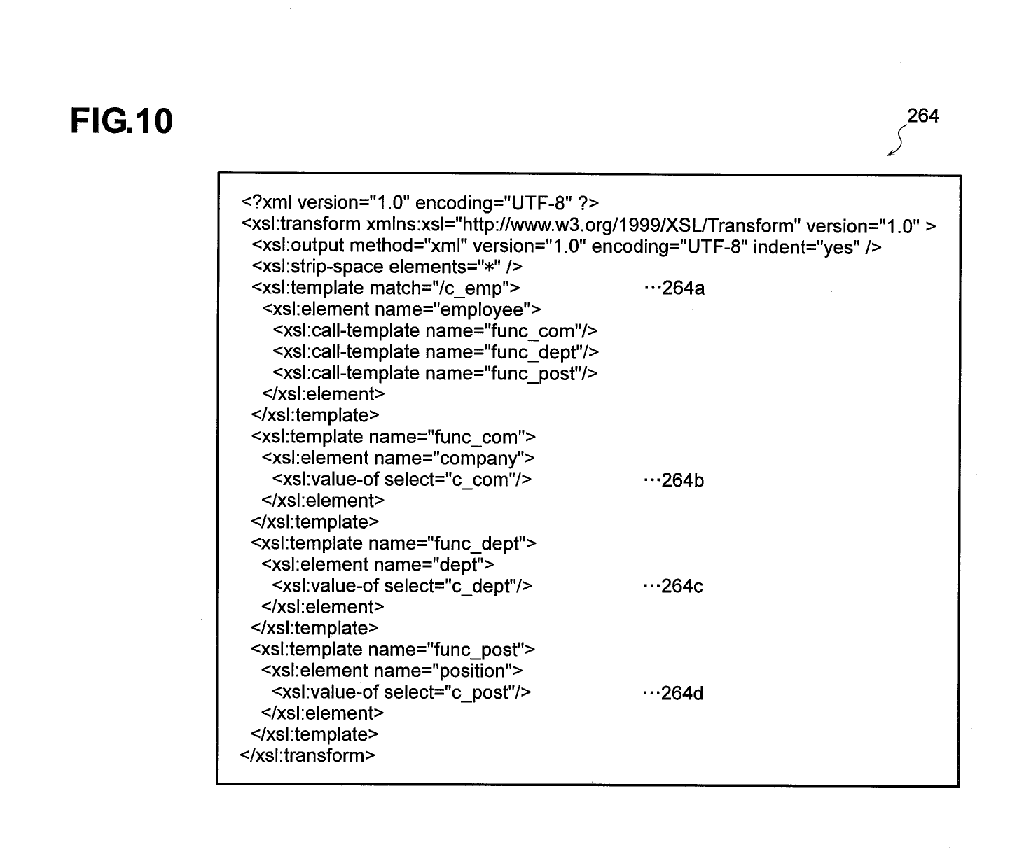

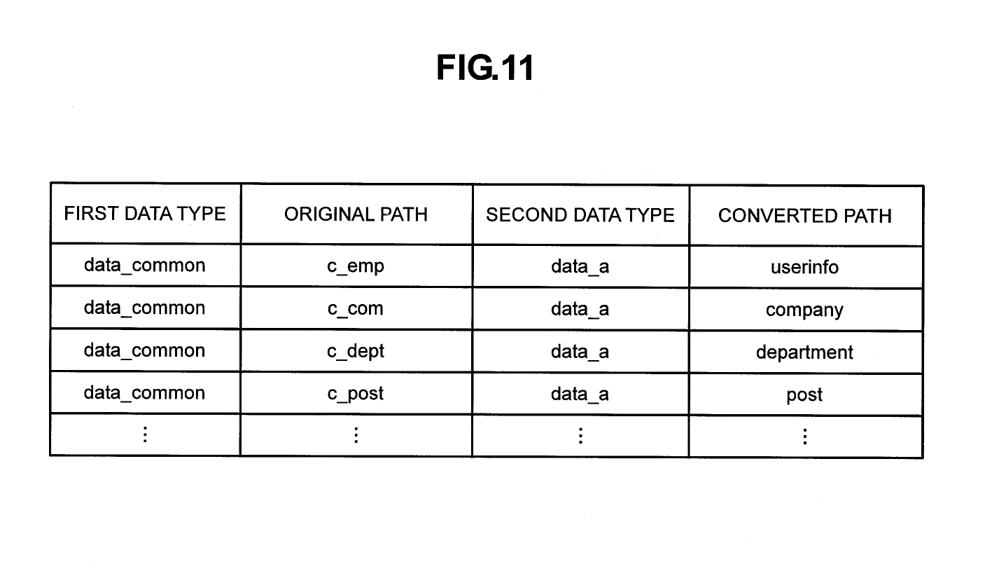

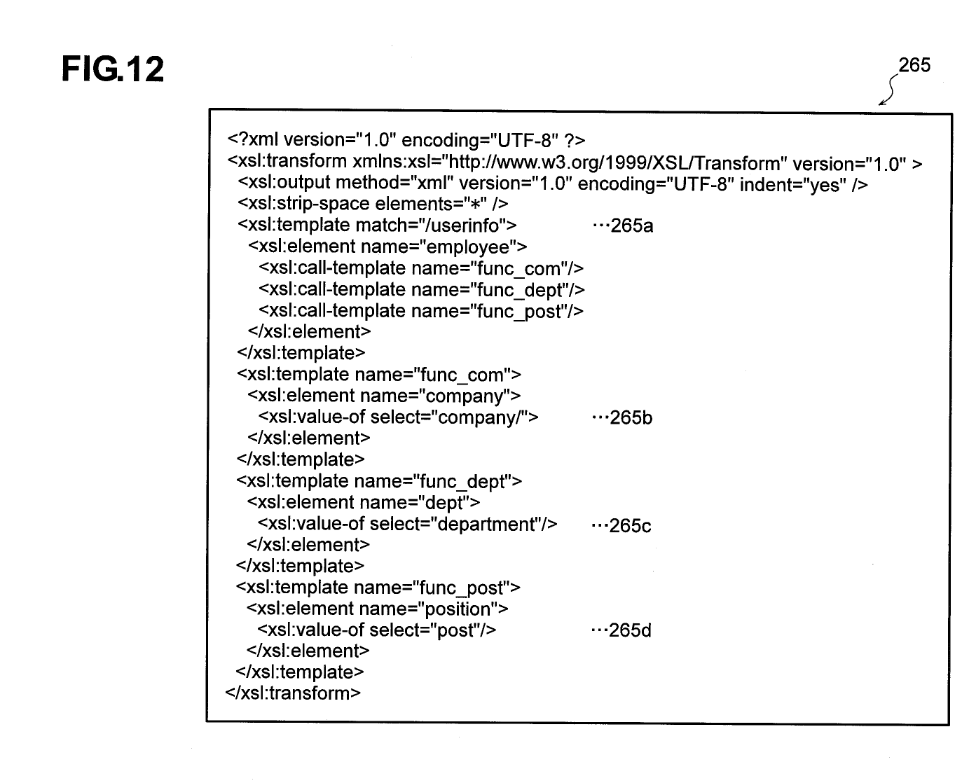

Performing processing above allows creating a data conversion definition 265 from data_a to data_g (refer to FIG. 12) when a data conversion definition 264 from data_common to data_g as shown in FIG. 10 is input through the input section 230 by replacing elements 264a, 264b, 264c and 264d, which are inputs of XPaths corresponding to data_common in the data conversion definition 264 from data_common to data_g by the XPaths corresponding to data_a (refer to FIG. 11) if a correspondence in an XPath between data_common and data_a as shown in FIG. 11 is stored in the path correspondence table 262.

In the data conversion definition 265 here, the XPath in elements 265a, 265b, 265c and 265d are replaced by those corresponding to data_a.

Notably, this embodiment assumes that the tag name is unique in the data conversion definition 264 shown in FIG. 10 and that a tag name is given based on a one-to-one correspondence. Thus, though the XPaths by which a parent-child relationship can be identified are not stored on the path correspondence table 262 as shown in FIG. 11, a tag name, which is not unique, or the conversion from one tag to a tag across multiple hierarchies requires to establish correspondences among XPaths and/or absolute location paths from a root node “/” for identifying parent-child relationships by storing them in the path correspondence table 262.

The embodiment described above assumes the path correspondence storage tables 162 and 262 are prestored in the path correspondence table storage areas 112 and 212.

For this reason, operators of the processing apparatus 100 and 200 may create the path correspondence storage table 162 and 262 and store them in the path correspondence table storage areas 112 and 212.

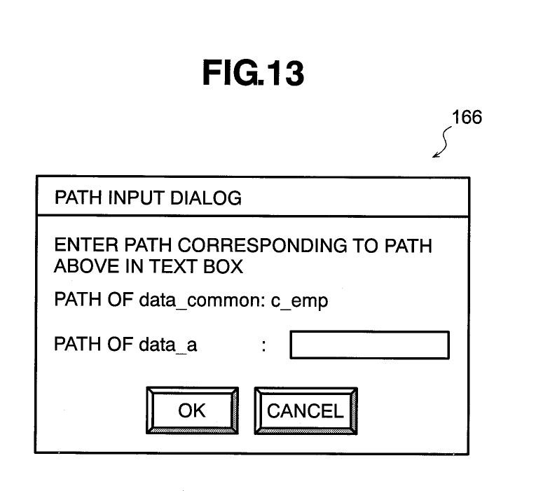

Operators of the processing apparatus 100 and 200 can create the path correspondence tables 162 and 262 easily by displaying a path input dialog screen 166 as shown in FIG. 13 on the output sections 140 and 240 and prompting the operators of the processing apparatus 100 and 200 to enter a corresponding path. Furthermore, necessary correspondences can be expanded in a stepwise manner thereby.

On an XSLT stylesheet employed in this embodiment, the position of a node subject to data conversion, that is, the original node position subject to data conversion is specified by an XPath, and a converted node position is specified by a tag name, which can also be used as an XPath. Thus, the XSL stylesheet can provide a correspondence among XPaths indicating one node position easily. Therefore, for example, the path correspondence tables 162 and 262 can be automatically created by the processing apparatus 100 and 200 as described below.

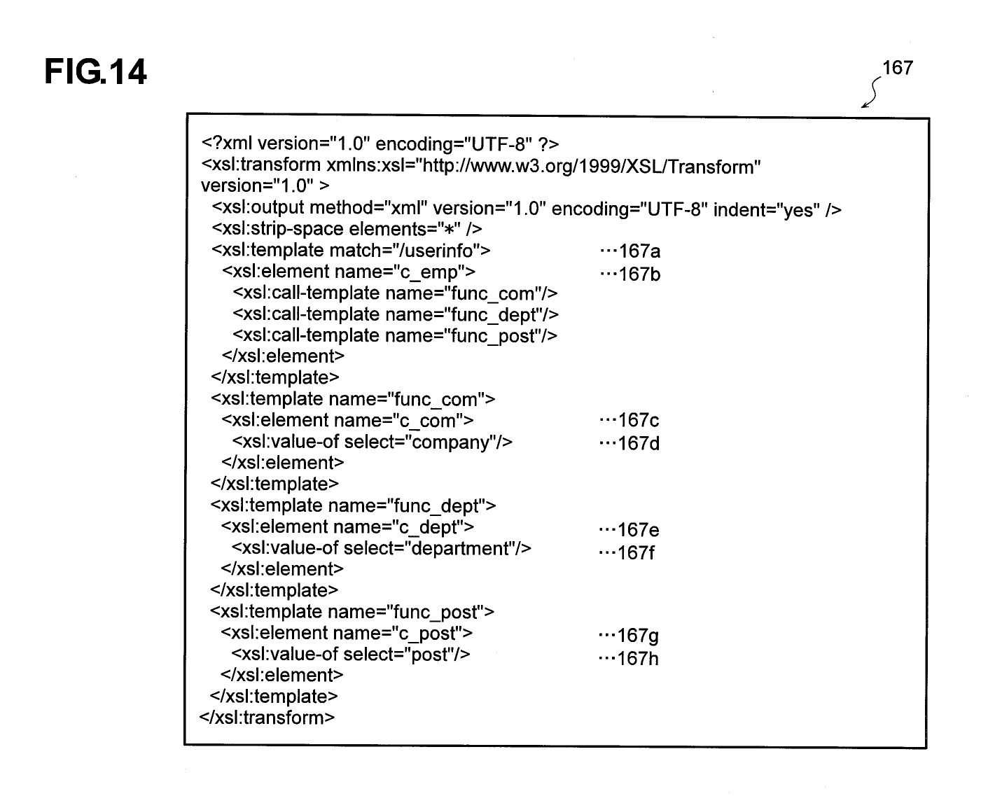

For example, in the data conversion definition 167 from data_a to data_common as shown in FIG. 14, the part “/userinfo” of the row 167a, “<xsl:template match=”/userinfo“>” if the parent element is “<xsl:template match=”/userinfo“>” is the original path. The part “c_emp” of the row 167b of the “<xsl:element name=“c_emp”> of the child element between the tags “<xsl:template>” is the converted path.

If a child element is “<xsl:value-of select=“aaaa”/>, the parts corresponding to “aaaa” on the rows 167d, 167f and 167h “<xsl:value-of select=“aaaa”/> are original paths. The parts corresponding to the part “bbbb” of the “xsl:element name=“bbbb”>, which is an element of “<xsl:template>” like the rows 167d, 167f and 167h are converted paths.

In this way, a path correspondence table can be created from a data conversion definition. Notably, having described that the path to read and the path to write in a data conversion definition are obtained separately, a path from a root may be established simultaneously with the analysis of a data conversion definition. Then, after the path to wire and the path to read are obtained, the path may be processed to a full path from the root and be stored in the applicable field of the path correspondence table.

The extraction of a path correspondence from a data conversion definition in this way can reduce the time for creating a path correspondence storage table.

In this embodiment, functions may be used in XPaths to be stored in the path correspondence tables 162 and 262 if the values obtained by using the XPaths are to be processed.

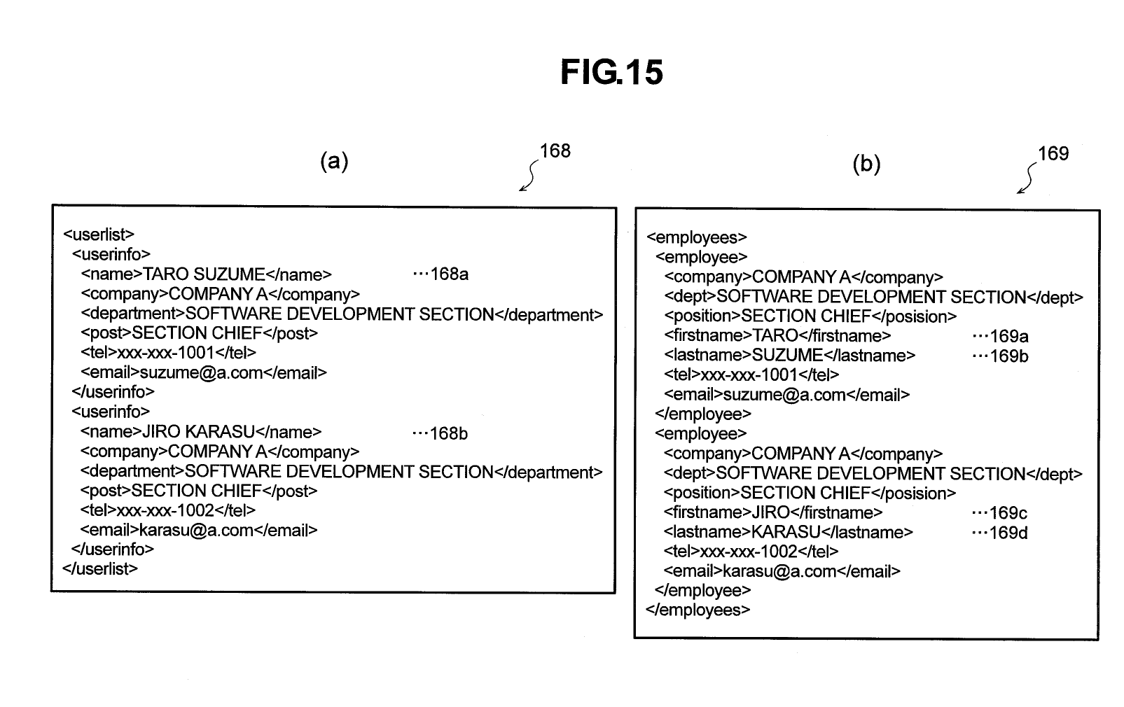

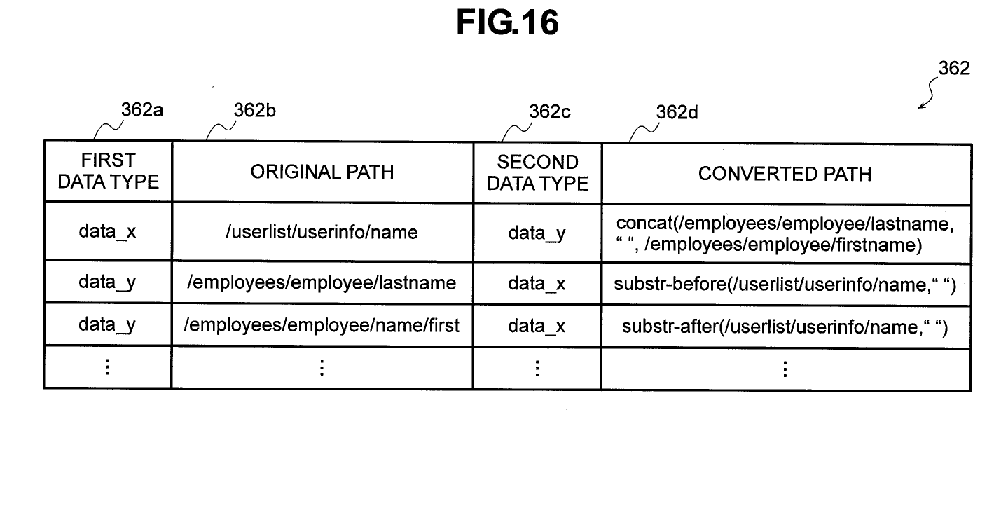

For example, as shown in FIG. 15(a), correspondences between structured data 168 having first names and last names in same data pieces 168a and 168b and structured data 169 having first names in data pieces 169a and 169c and last names in data pieces 169b and 169d may adopt a path correspondence table 362 storing XPaths having functions as shown in FIG. 16.

For example, the concat function used in the XPath “concat(/employees/employee/lastname, /employees/employee/firstname)” stored in a converted path field 362d of the path correspondence table 362 is a function that concatenates strings given by arguments. FIG. 16 shows that “/userlist/userinfo/name” corresponds to the string concatenating the string “/employees/employee/lastname”, a space “ ” and the string “/employees/employee/firstname”.

The substr-before function used in the XPath “substr-before(/userlist/userinfo/name,” stored in the converted path field 362d of the path correspondence table 362 is a function for obtaining a string described before one string. In this case, “/employees/employee/lastname” corresponds to the string before the space “ ” in the “/userlist/userinfo/name”.

The substr-after function used in the XPath “substr-after (/userlist/userinfo/name,” stored in the converted path field 362d of the path correspondence table 362 is a function for obtaining a string described after one string. In this case, “/employees/employee/firstname” corresponds to the string after the space “ ” in the “/userlist/userinfo/name”.

Storing a correspondence between/among XPaths having a function in the path correspondence table 362 allows more flexible description of correspondences.

In this embodiment described above, the value depending on an external factor can be described in a condition of an XPath by embedding a variable in the XPath.

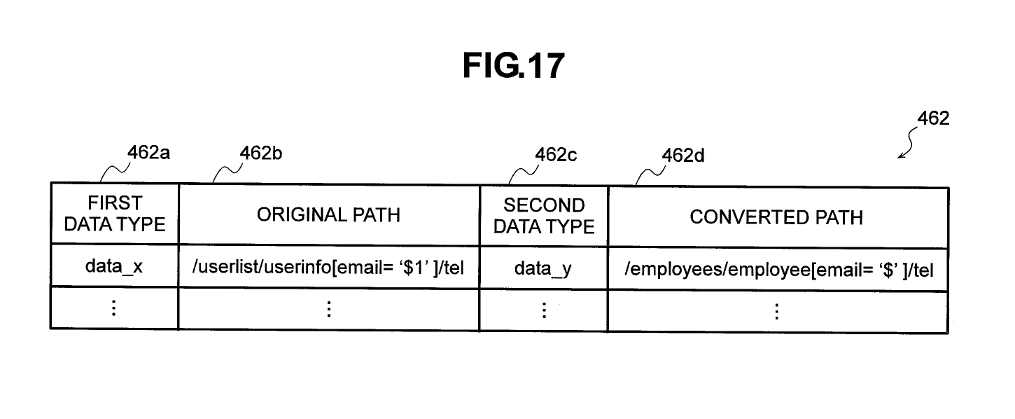

For example, a variable is embedded in the XPaths stored in the original path field 462b and converted path field 462d in the path correspondence table 462 shown in FIG. 17. Notably, in FIG. 17, “$1” is a variable.

For example, the telephone number of the employee having “suzume@a.com” as an “email address” can be obtained by storing it in the original path field 462b as “/userlist/userinfo[email=‘suzume@a.com’]/tel”.

The “email address” may depend on an external factor (such as an input by a user of a system). In this case, as described in “/userlist/userinfo[email=‘$1’]/tel”, the part which may be changed due to an external factor” may be embedded within a path.

By doing so, the XPath “/employees/employee[email=‘$1’]/tel” in a structured data piece, data_y, can be obtained from the XPath “/userlist/userinfo[email=‘$1’]/tel” in the structured data piece, data_x, by using path converting section 121. Thus, by replacing the part “$1” of the obtained path by “suzume@a.com”, the structured data piece, data_y, can be searched in the same manner as that on the structured data piece, data_x.

The establishment of a path correspondence table having a variable embedded in a path allows a flexible search based on an external factor.

In the first embodiment above, whether the XPath obtained by the path converting section 121 is stored in the original path field 162b or not is checked. If not, the XPath corresponding thereto cannot be obtained. In this case, the data type may be converted to a different data type, and a specific value may be obtained then by using the XPath stored in the path correspondence table 162.

Referring back to the embodiment in FIG. 6, examples of advantages thereof will be described.

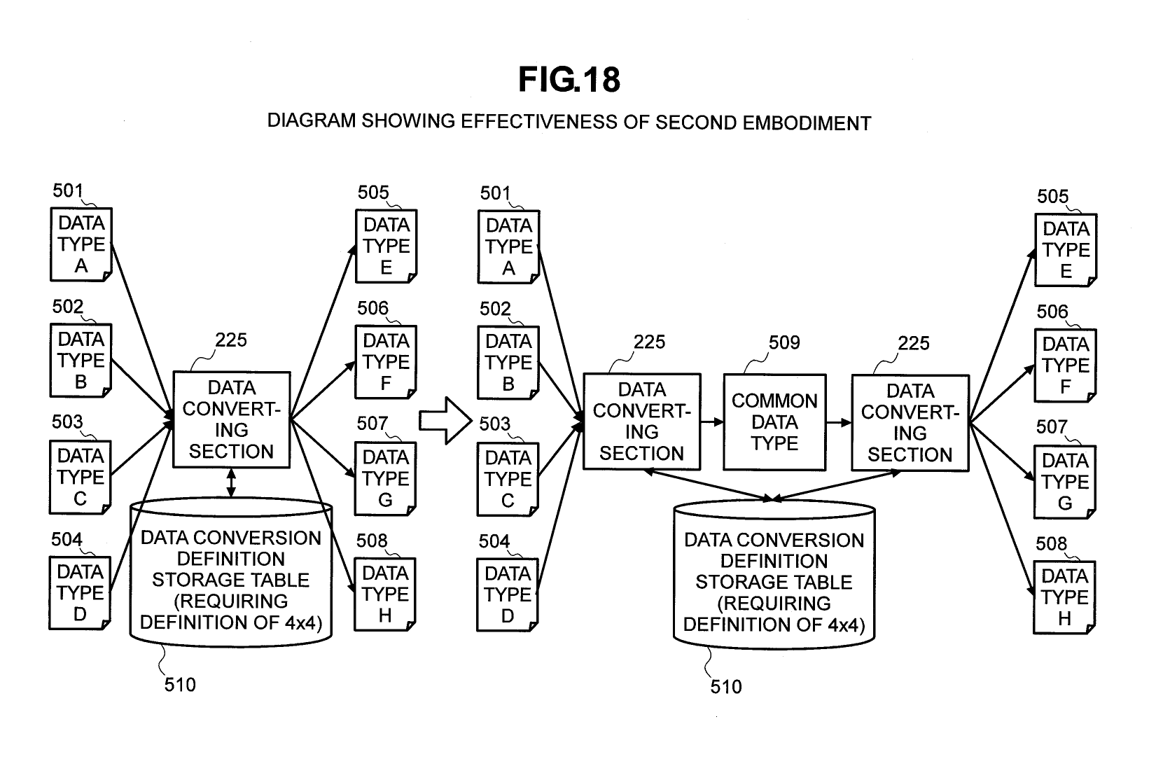

As shown in the left side of FIG. 18, data types A501 to D504 are required to convert to data types E505 to H508 through the data converting section 225 here.

In order to do so, 4×4=16 data conversion definitions must be prepared. For the reduction of the time for creating the 16 data conversion definitions, a method using a common data type 509 is adopted conventionally. In this case, the data types A501 to D504 is converted to the common data type 509 first, and the common data type 509 is then converted to the data types E505 to H508 as shown in the right side of FIG. 18. This method deteriorates the performance since the data conversion is performed twice though 4+4=8 conversion definitions are only required instead of 16 conversion definitions. According to the second embodiment, 16 data conversion definitions can be automatically created in advance by preparing a path correspondence table for the data types A501 to D504 and the common data type 509 and data conversion definitions from the common data type 509 to the data types E505 to H508. Using this method can prevent the deterioration of the performance since data conversion is required only once.

A third embodiment of the invention will be described. In the embodiment in FIG. 6, a new data conversion definition is created in advance by converting an original path described within a data conversion definition.

In the third embodiment, an original path is created by using a path converting section and a value obtaining section when data conversion is performed, without creating a new data conversion definition. Then, the created path is used to obtain a necessary value directly from original structured data that the data conversion definition does not expect. The schematic diagram of the processing apparatus is equivalent to the one in FIG. 6 excluding the data conversion definition creating section 224.

Like the embodiment in FIG. 6, the data conversion definition 264 from data_common to data_g shown in FIG. 10 and a path correspondence table between data_common and data_a shown in FIG. 11 are prepared. When the conversion from original data, data_a, to data_g is performed, data conversion processing is performed by converting the path of data_common included in the data conversion definition 264 in FIG. 10 to the path of data_a based on the path correspondence table in FIG. 11.

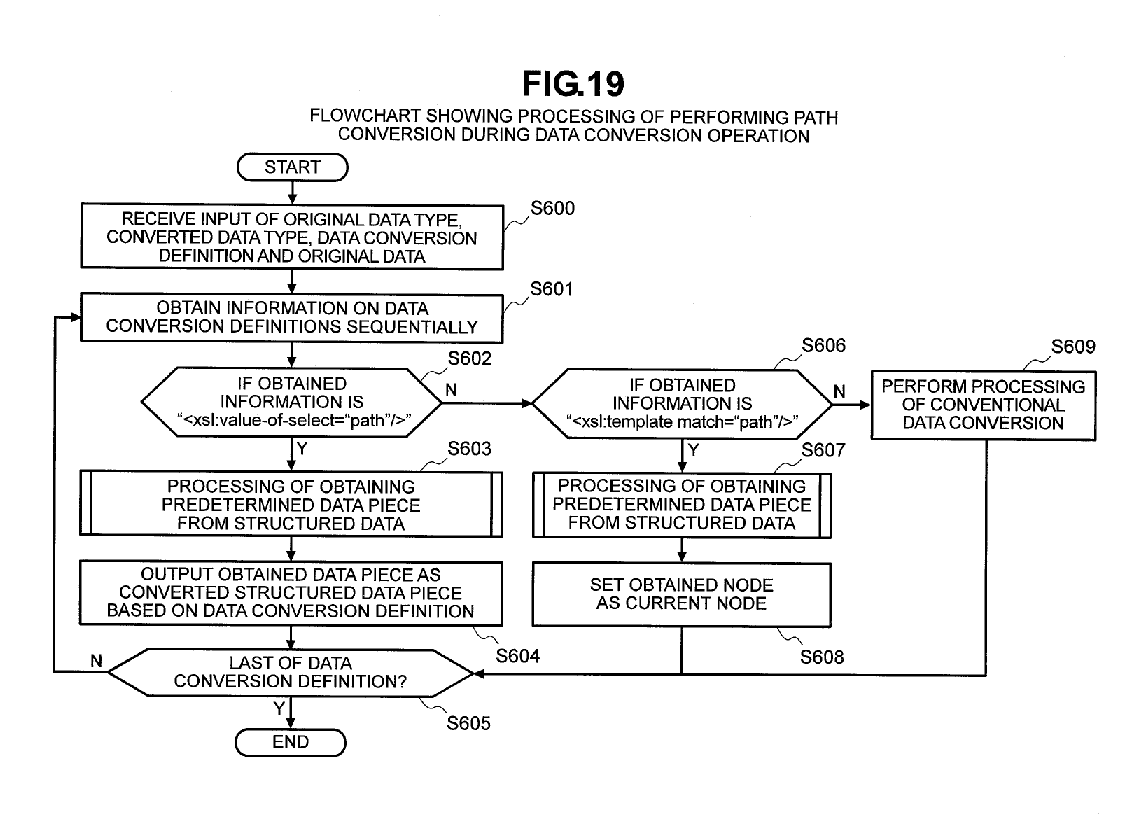

FIG. 19 shows an example of the processing flow for performing path conversion when data conversion is performed. For easy description, processing limited to the data conversion definition 264 in FIG. 10 will be described. FIG. 10 is an example using an XSLT stylesheet as a data conversion definition. In reality, more processes must be added for addressing all variations representable by XSLT stylesheets. However, the processes will be omitted herein.

First of all, the inputs of an original data type, converted data type, data conversion definition and original data are received (S600). Next, a description in the data conversion definition is sequentially obtained (S601). If the obtained description is “<xsl:value-of select=“path”/> (S602), the processing of obtained a predetermined data piece from structured data shown in FIG. 5 is performed by using the original data type, converted data type and the path included in the obtained description as arguments (S603). Then, the obtained data is output (S604) as a converted structured data piece based on the data conversion definition.

If the obtained description is “<xsl:template match=“path”>” (S606), processing of obtaining a predetermined data piece from a structured data piece shown in FIG. 5 is performed by using the original data type, converted data type and the path included in the obtained description as arguments (S607). In this case, not a value but a node is obtained as the data piece. The obtained node is set as a current node (S608). The expression, “current node” refers to the node being processed currently within original data. The processing of data conversion is advanced by changing the current node.

If the obtained description is not the one above, the processing of conventional data conversion (S609) is performed.

As a result of one of the processing, whether the last of the data conversion definition has been processed or not is checked (S605). If not, the processing from S601 is repeated, and the processing ends when the last of the data conversion definition is processed.

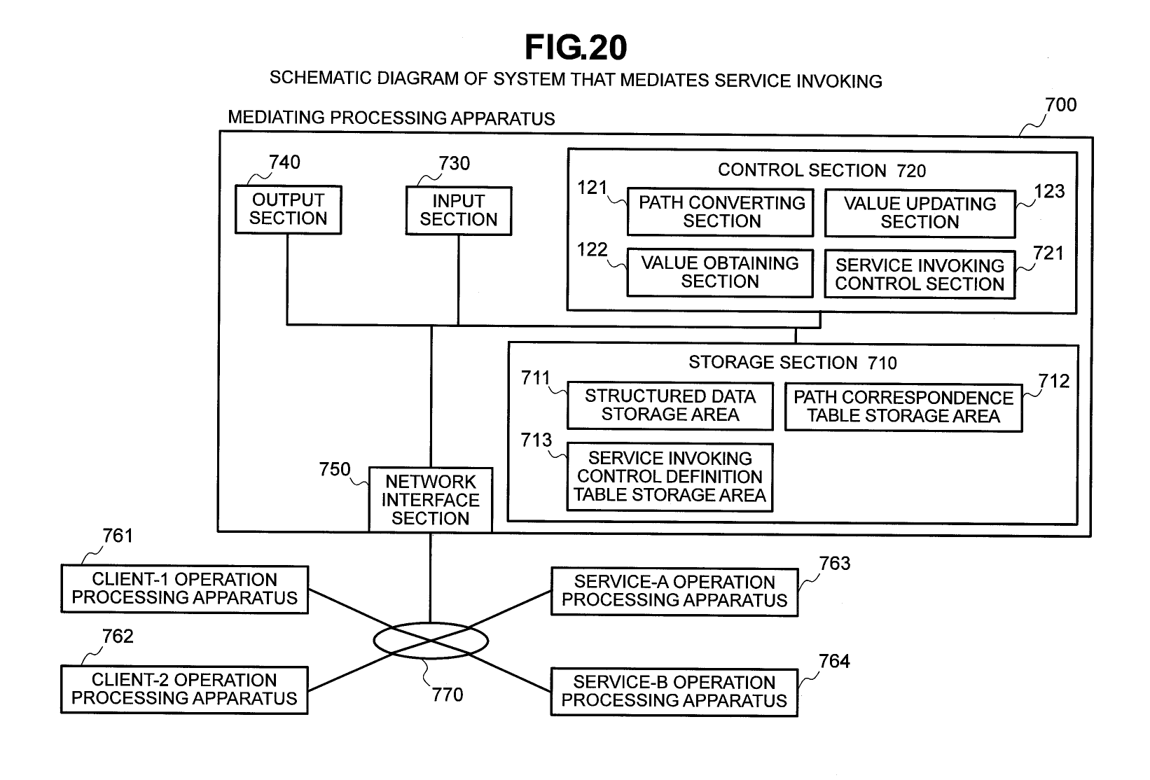

FIG. 20 is a schematic diagram of a processing apparatus, which is a fourth embodiment of the invention.

According to this embodiment, a system is established by connecting software functions to be implemented on processing apparatus, which are called services. The connection of services by using a mediating processing apparatus 700 looses the relationships among services. Thus, the mediating processing apparatus 700 is only required to change when the system is changed, which advantageously reduces the costs for the changes.

The mediating processing apparatus 700 includes the processing apparatus 100 of the first embodiment and further includes a network interface section 750, a service invoking control section 721, a service invoking control definition table storage area 713. Having described the network interface section 750 as a part of the input section 130 and output section 140 in the processing apparatus 100 of the first embodiment, the network interface section 750 is described here separately from an input section 730 and an output section 740 for easy description. A client-1 operation processing apparatus 761, a client-2 operation processing apparatus 762, a service-A operation processing apparatus 763 and a service-B operation processing apparatus 764 are connected over a network 770. The client-1 operation processing apparatus 761 is a processing apparatus that transmits request data 1 that requests processing to the system and receives the result. The client-2 operation processing apparatus 762 is a processing apparatus that transmits request data 2 in a different form from that of the request data 1 that requests processing to the system and receives the result. The service-A operation processing apparatus 763 and service-B operation processing apparatus 764 are processing apparatus in which a software function is operating which performs specific processing in accordance with a request and returns the result.

The client-1 operation processing apparatus 761 and client-2 operation processing apparatus 762 transmit request data to the mediating processing apparatus 700 over the network 770. The mediating processing apparatus 700 receives the request data through the network interface section 750 and places the received request data in the structured data storage area 711. The service invoking control section 721 controls service invoking in accordance with the description of the request data.

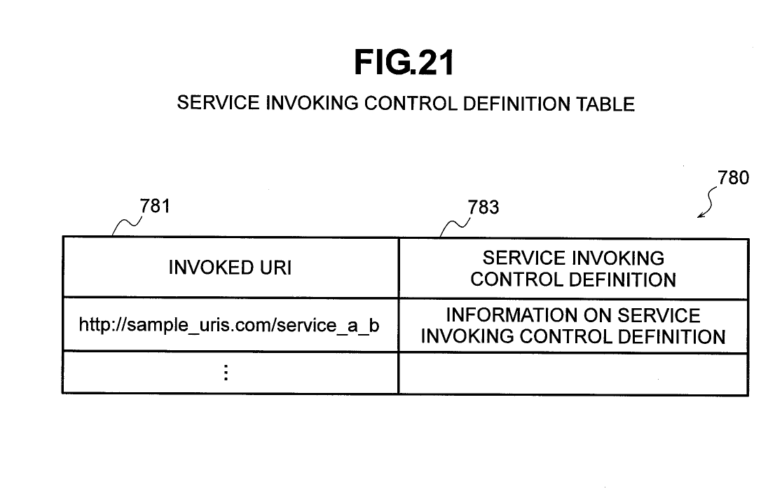

How to perform service invoking control is implemented as a service invoking control definition. This defines a method of processing on request data and/or a method of processing the order of invoking services and/or return values of services and is a kind of program. The service invoking control definition is stored in the service invoking control definition table storage area 713. FIG. 21 shows an example of the service invoking control definition table 780. The service invoking control definition table 780 includes an invoked URI 781 and a service invoking control definition 782. The invoked URI 781 stores a URI of the destination to which request data is transmitted when a client requests processing. Here, “http://sample_uris.com/service_a_b” is handled as the invoked URI, and the client-1 operation processing apparatus 761 and client-2 operation processing apparatus 762 transmit request data to the URI. The protocol for the data exchange uses HTTP. The service invoking control definition 782 stores a description of a service invoking control definition.

The service invoking control section 721 obtains the description of the service invoking control definition corresponding to the invoked URI 781 from the service invoking control definition table 780 to process. The path converting section, value obtaining section and value updating section are properly used in order to operate a structured data piece such as request data during the processing.

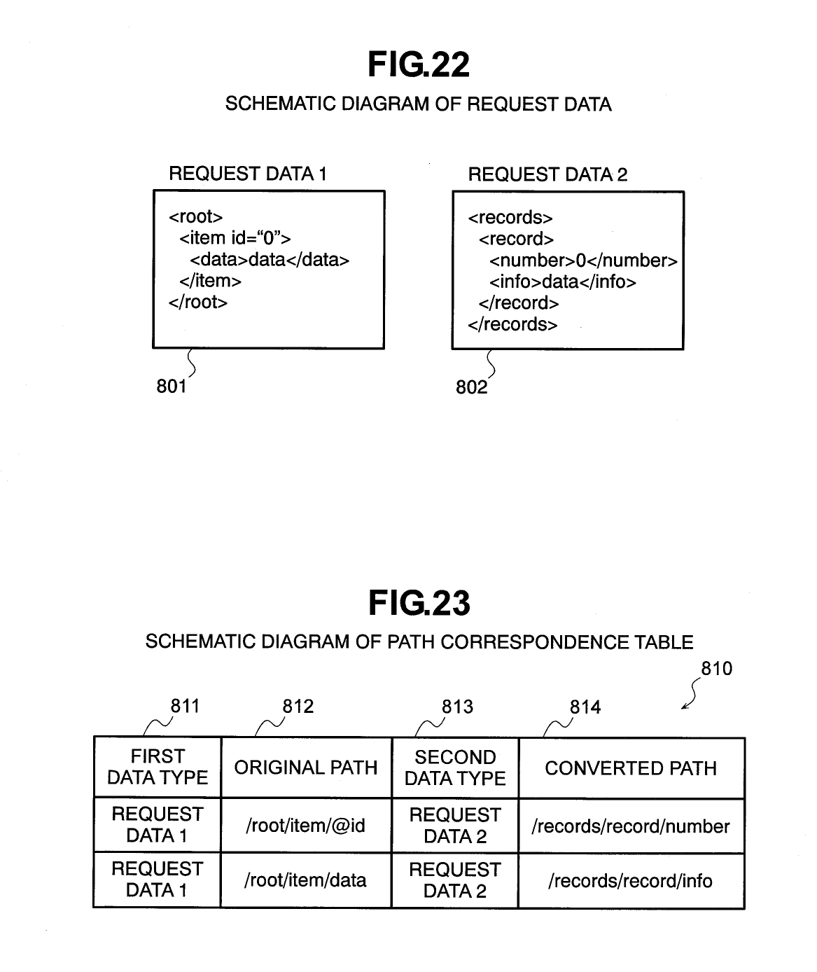

FIG. 22 shows examples of request data 1 (801) and request data 2 (802). The request data 1 (801) has “root” as a root element and “item” as a child element thereof. The “item” has “id” as an attribute. In this example, the value of the “id” is “0”. The “item” further has “data” as a child element. In this example, the value of the “data” is “data”. The request data 2 (802) has “records” as a root element and “record” as a child element thereof. The “record” further has “number” and “info” as child elements. In this example, the value of the “number” is “0”, and the value of the “data” is “data”.

FIG. 23 shows a path correspondence between the request data 1 (801) and the request data 2 (802). The “/root/item/@id” of the request data 1 (801) corresponds to the “/records/record/number” in the request data 2 (802). The “/root/item/data” of the request data 1 (801) corresponds to the /records/record/info” in the request data 2 (802).

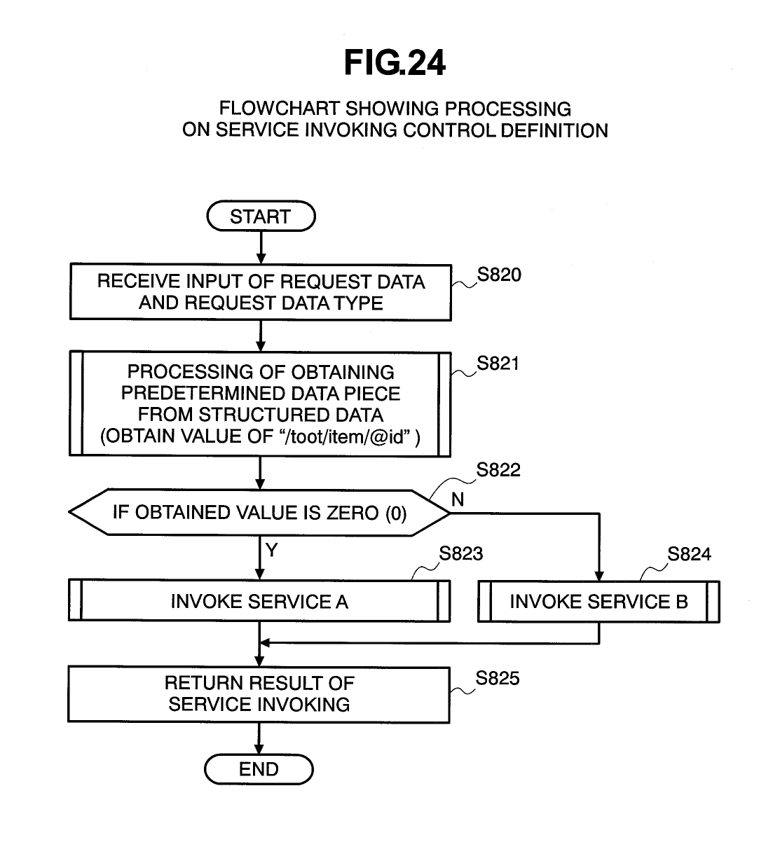

FIG. 24 shows an example of the processing flow for a service invoking control definition to be executed in the service invoking control section 721. The service invoking control definition in this example expects the request data 1 (801) as a data type. In other words, the path described in the processing flow is assumed as a path of the request data 1 (801).

The inputs of request data and a request data type are received as arguments (S820). Next, processing of obtaining a predetermined data piece from a structured data piece (S821) is performed. The processing is the processing shown in FIG. 5 and provides a request data type as an original data type, the request data 1 (801) as a converted data type and “/root/item/@id” as an XPath. If the obtained value is “0” (S822) as a result of the processing, a service A is invoked (S823). If not (S822), a service B is invoked (S824). The result of the invoking of one of the services is returned to the invoking client, and the processing ends. In this example, the service A operates in the service-A operation processing apparatus 763, and the service B operates in the service-B operation processing apparatus 764. The invoking is performed over the network 770.

The service invoking control definition to be executed by the service invoking control section 721 may not be stored in the service invoking control definition table storage area 713, but the service invoking control section 721 may involve an equivalent definition.

Having described that this example is applied in a case that a value is obtained from request data, the response data obtained as a result of the invoking of a service may be a structured data piece, and multiple kinds of response data may exist. In this case, a path to a specific structured data piece may be only required to describe in a service invoking control definition, and a path correspondence table between the specific structured data piece and each kind of other response data may be prepared to address multiple kinds of response data.

Having described in this example that a value is only obtained, the request data to be used for invoking the service A or service B, for example, may be a structured data piece, and request data may have different forms among services to be invoked. Alternatively, the forms of the response data expected by each of the client 1 and client 2may differ, or response data may be created by updating a partial value identifiable in a path of response data. In these cases, the path converting section 121 and value updating section 123 may be used. This processing can be implemented by changing step S170 of receiving the inputs of an original data type, a converted data type and an XPath in FIG. 5 to a step of receiving an original data type, a converted data type, an XPath and an update value and replacing steps S172 and S174 of obtaining data by using the input XPath by a step of updating data by using the input XPath.

Conventionally, when request data in a form that the service invoking control section 721 does not expect reaches, the request data is converted to the expected form in advance, which is then given to the service invoking control section 721. However, the application of the fourth embodiment eliminates the necessity for performing the data conversion. The path conversion must be performed instead, but the path conversion can be performed more significantly fast by using a partial value for reference than the data conversion in which all of elements in a structured data piece must be converted. Therefore, the deterioration in performance due to the data conversion can be prevented.

The fourth embodiment performs path conversion upon implementation, and the deterioration in performance due to the path conversion, which may be less than that due to the data conversion, is concerned. Now, a fifth embodiment for preventing the deterioration in performance due to the path conversion will be described.

The construction of this embodiment includes the control section 720 in FIG. 20 further having a service invoking control definition creating section. The construction of the service invoking control definition table is also changed.

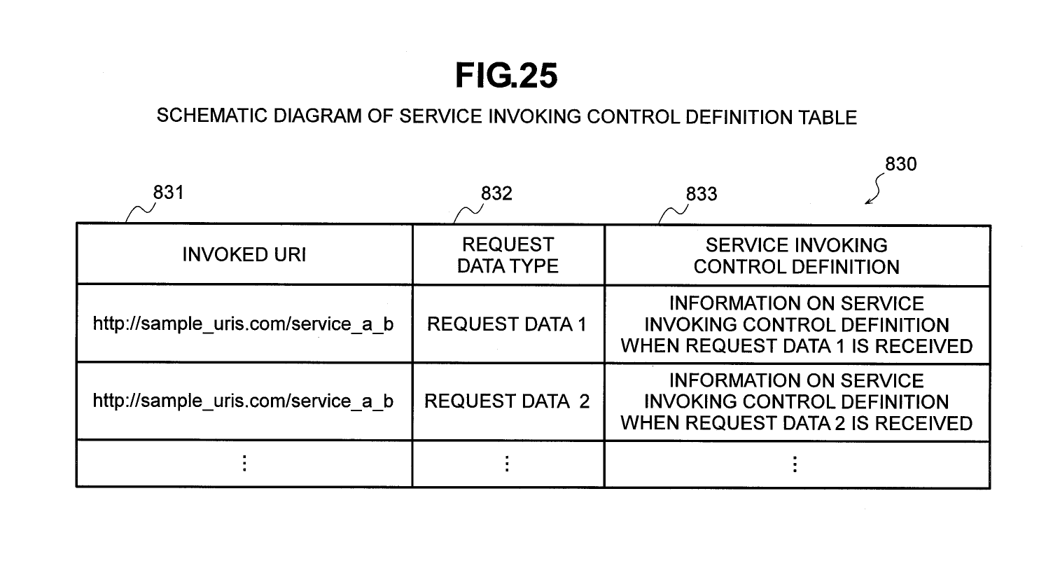

FIG. 25 shows an example of a service invoking control table 830. The service invoking control table 830 includes an invoked URI 831, a request data type 832, and a service invoking control definition 833. The invoked URI 831 stores a URI of the destination to which a client transmits request data to request processing. The request data type 832 stores a type of request data reaching to the service invoking control section 721. The service invoking control definition 833 stores a description of a service invoking control definition.

The service invoking control section 721 obtains and executes the service invoking control definition 833 from the service invoking control definition table 830 in accordance with the invoked URI 831 and the reaching request data type 832.

The service invoking control definition creating section creates a service invoking control definition and stores it in the service invoking control definition table 830.

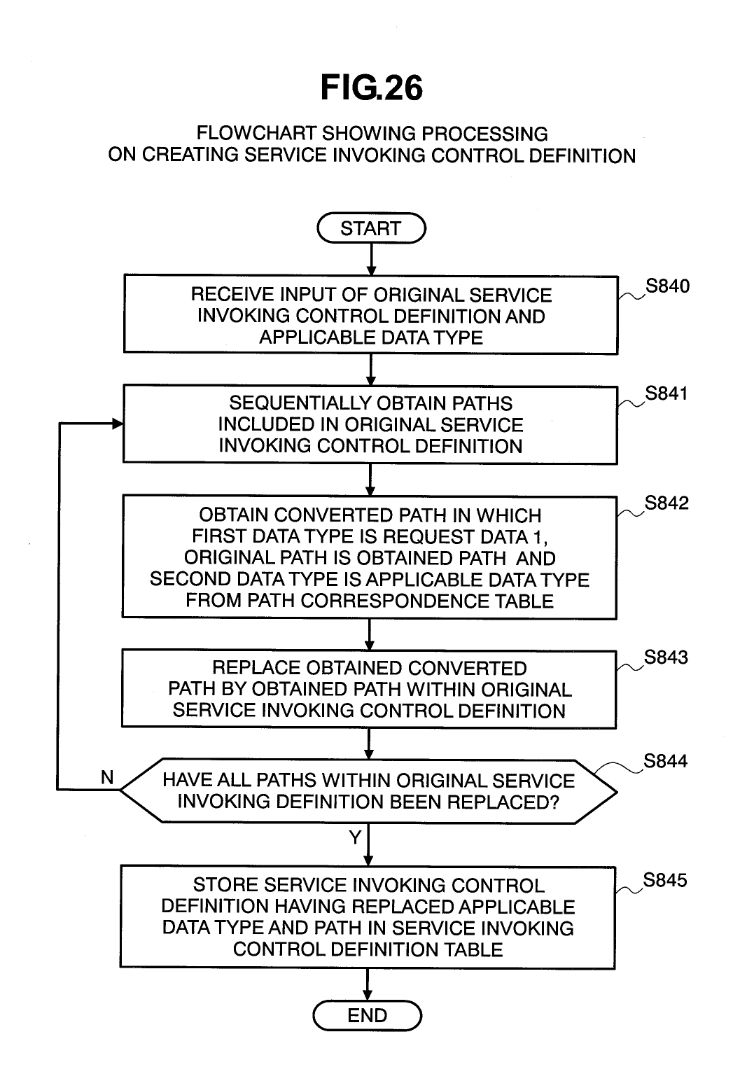

FIG. 26 shows a processing flow thereof. In this case, a service invoking control definition (which corresponds to the processing flow including a “step (S172) of obtaining data by using an input XPath” instead of the “step (S821) of obtaining a predetermined data piece from a structured data piece” in FIG. 24) and a path correspondence table 810 shown in FIG. 23 are prepared in advance. First of all, the inputs of an original service invoking control definition and an applicable data type are received (S840). In this example, the original service invoking control definition is a service invoking control definition for request data 1, and the applicable data type is request data 2. Next, a path included within the original service invoking control definition is sequentially obtained (S841). A converted path having the request data 1 as a first data type, an obtained path as the original path and the applicable data type as the second data type is obtained from a path correspondence table (S842). The obtained converted path is replaced by the obtained path within the original service invoking control definition (S843). If all of the paths within the original service invoking control definition have not been replaced (S844), the processing from step S841 is repeated. If all paths have been replaced (S844), the service invoking control definition having the replaced applicable data type and path is stored in the service invoking control definition table (S845), and the processing ends.

For easy description on this embodiment, the invention is applied to request data. However, the invention is not limited to request data, but the invention may be applied to other kinds of structured data to be used in service invoking control definitions.

Creating a service invoking control definition in advance in accordance with the type of structured data to be handled in this way can eliminate the necessity for performing path conversion upon execution. Thus, the mediating processing apparatus 700 can be provided which has better performance than that of the fourth embodiment.

1. A processing apparatus comprising:
a storage section that stores a first structured data piece having at least one item;
an obtaining section that obtains a description relating to the item from the first structured data piece; and
a converting section that converts second position information for locating an item of a second structured data piece in a different representation form from that of the first structured data piece to first position information for locating the item of the first structured data piece,
wherein the obtaining section obtains a description relating to the item from the first structured data piece by using the first position information converted by the converting section.
